(19) United States
(12) Patent Application Publication
(10) Pub. No.: US 2017/0252833 A1
(43) Pub. Date: Sep. 7, 2017

(54) RIGID SELF RETRACTING ERGONOMIC TELESCOPIC DEVICE, FOR DRILLS THAT PROTECTS THE USER, COLLECTS WASTES, FIXED MEASUREMENT DRILLING, INCREASES THE CONTACT AREA, ALLOW THE TOTAL VIEWING AND IF IT'S NECESSARY DOSING LUBRICATION; AND ITS ASSEMBLY PROCESS

(71) Applicant: Victor Martin BAYONA SALAZAR, Bogota (CO)

(72) Inventor: Victor Martin BAYONA SALAZAR, Bogota (CO)

(21) Appl. No.: 15/039,991

(22) PCT Filed: May 20, 2016
(86) PCT No.: PCT/IB2016/052988

§ 371 Date: May 27, 2016

(30) Foreign Application Priority Data
Mar. 4, 2016 (CO) 16-56828

(51) Int. Cl. B23B 49/00; B23Q 11/10; B25F 5/02; B23Q 11/00

(52) U.S. Cl. CPC B23B 49/008; B23Q 11/0071; B23Q 11/1092; B25F 5/026; B23B 2250/12; B23B 2260/004; B23B 2260/0482

(57) ABSTRACT

The device is self retractable, of rigid material in telescopically, it can be installed in all types of drills: home and industrial, wired and wireless, which conforms to the bases where the mandrel holder bits; thus covering completely the drill, thus avoiding the risk of contact with hands that drill, drill during handling; other under this device is to set the measure, according to the need of drilling and allow this to be perfectly repeatable; also allows maximum collecting waste, thereby protecting the goods and goods and because independent deposit the mandrel extends the life of the drills and isolating such waste; it can also be made of transparent materials that allow complete visualization of the drill.

### CROSS RELATED REFERENCES

This application claims the benefit of the filing date of the international patent application PCT/IB2016/052988 entitled “RIGID SELF RETRACTING ERGONOMIC TELESCOPIC DEVICE, FOR DRILLS THAT PROTECTS THE USER, COLLECTS WASTES, FIXED MEASUREMENT DRILLING, INCREASES THE CONTACT AREA, ALLOW THE TOTAL VIEWING AND IF IT'S NECESSARY DOSING LUBRICATION; AND ITS ASSEMBLY PROCESS”, which was filed on May 20, 2016, by the same inventor of this application. That international application is incorporated herein by reference as if fully set forth herein.

### FIELD OF THE INVENTION

The present invention relates to devices for capturing the swarf or chips produced by drilling operations and more particularly to a removable boot device that also allows the user to have precise control of the drilling depth required.

### BACKGROUND OF THE INVENTION

At present there is no device that simultaneously protect the physical integrity of the user, allowing to have precise control of the drilling depth required, collect and store the result of drilling waste, without losing the ability to display the drill while piercer, and have a more ergonomic grip that increases the possibility of a force more evenly and distributed and also in special applications perforated (glass, acrylic, metal, steel . . . ) can be dosed supply of coolant; since at present the following disadvantages or problems occurs: The holes do not have security measures to ensure safe handling of injury when the drill is in operation, the contact area at once the drilled this reduced only the tip of the bit difficult so the beginning of all perforations, and sometimes breaking drills or inaccuracy of the perforated either forming unwanted bending angles or squirts the initially planned site; this also hinders the grip and the possibility of increased thrust force is evenly distributed to facilitate said perforated.

Some artifacts intended to solve only one of many problems discussed above, such as collecting dust but only vertical wall, because they can not do to ceiling, and require complex vacuum systems employing an engine and therefore batteries becoming rather expensive and complex to use, and does not solve the main thing is to protect the physical integrity of the user, or allow to have precise control of the drilling depth required, also it gives us a more ergonomic grip that increases the possibility of a force more evenly and distributed, or help on special perforated applications (glass, acrylic, metal, steel . . . ); other devices are only intended to solve the problem of collecting dust to ceiling but all residues fall or reach the mandrel, reducing the life of the tool, and creating a turbulence which increases the dust particles suspended in air; and by using flexible materials do not solve the main thing is to protect the physical integrity of the user, or allow to have precise control of the drilling depth required, also it gives us a more ergonomic grip that increases the possibility of a force more evenly and distributed or increases the contact area of the surface to be drilled, or help on special perforated applications (glass, acrylic, metal, steel . . . ).

Other devices use complex vacuum systems, such as hoses, vacuum cleaners, ducts, etc., which makes them complex and expensive and do not solve the main thing is to protect the physical integrity of the user, or not allow you to have precise control of the drilling depth required, either give us a more ergonomic grip that increases the possibility of a force more evenly and distributed, or increase the contact area of the surface drilling, much less help in special applications perforated (glass, acrylic, metal, steel . . . ). Such patents mentioned above are intended to provide a solution that partially are:

U.S. Pat. No. 3,583,821 This application relates to a protective safety device and chip catcher to catch and retain dust, shavings and waste from a drilling operation, and having the shape of a receptacle of flexible transparent material attached to the chuck and that surrounding the drill and forming with the surface a sealed enclosure drilled, the flexible walls of the receptacle being normally elastically extended but the collapse gradually as the operation proceeds drill and drill bit penetrates deeper into the surface being drilled.

U.S. Pat. No. 5,653,561 This application relates to a metal cutting comprising a flexible, resilient, generally frustaconical, unitary member for capturing shavings, cuttings, dust and debris from drilling operations. The trunk has two open ends, namely a proximal end adapted to receive and maintain the drill body, and a distal end adapted to engage a surface to be drilled. In between the two extremes, the cabin chip comprises a generally frusta-conical, undulating body, the chuck on the inside of the boot is received. The inner dimension of the boot is substantially greater than the outer diameter of the mandrel. Thus, the boot surrounds but does not contact with the chuck, allowing the mandrel to rotate freely, while the trunk of the invention remains stationary. Optionally, the boot may include an outlet conduit for attachment to a vacuum to remove swarf during drilling operations. The boot may also include a handle at the distal end of the boot.

WO2007140013 This application relates to a drill bit (20) made of a shaft (20) including a fan (30) on the shaft having at least one blade (31); and related attachment hole (10) for dust and refuse collection made of a handle (4); the housing body (25) having a front (8) and rear (12) portion and a top and bottom, so that the bottom is connected to the handle and the body of the housing contains an opening gap (9) perpendicular to the handle; a nozzle (1) which is connected to the front of the housing body; the bit (20) comprising a shaft (2) including a fan (30) on the shaft having at least one blade (31) within said hollow circular opening (9); and a receptacle (3) for collecting dust and debris while the drill is in use.

U.S. Pat. No. 7,322,429 This application relates to aAs portable drilling machine includes a housing; one chuck positioned on a front surface of the housing; a drill bit detachably coupled to the mandrel; a conductor located inside the housing to provide either the bit or chuck with a rotational driving force; a dust cover having an anti rear dust cover formed in a cup shape with a drill through hole formed in a central region of a lower surface of the rear dust cover and dust cover front formed in the form tube to engage the back cover anti-dust, before being adapted anti-dust cover to move toward the lower surface of the rear dust cover when it acted under pressure into the housing and return to the original position when eliminates pressure; and a retainer removably attaching the dust cover anti back to an outer surface of either the housing or the chuck. The rotational movement of the drill is not interfered with by the anti dust cover, and the dust collection space increases.

U.S. Pat. No. 6,830,113 This application relates to a dust suppression cover including a cover defining an enclosed space. The protector also includes a clamp mounted adjacent a first end of the cover, a reinforcing member attached to a central portion of the cover and a boot attached adjacent a second end of the cover. Dust suppression also includes a hose mounted on this and extends through the cover in communication with the closed space. This suppression system may include a vacuum source having a vacuum hose attached where the vacuum hose is connected to the hose mounted on and extending through the shroud.

The present invention addresses all the above problems and overcomes the above presentation WO2014/067497 the applicant, this invention relates to a device for covering a drill and chuck, designed to protect the operator against risks posed by the rotating drill bit, to facilitate handling of the tool and to collect dust produced during use, without affecting the free rotation of the mandrel. The cover device is installed drill quickly and easily in the mandrel and contracts as the bit penetrates the surface. The device consists of three stacked tubes, namely a coupling tube, a connector tube and a sliding tube; since the current universal retractable car, rigid with ergonomic grips, which protects the user equipment, telescopic device fixed as drilling, collects waste, increases the contact area, allows full view and if necessary metered lubrication; manages to provide a device with a universal retractable auto configuration, rigid material telescopically, which is designed so that it can be installed in all kinds of drills, from home to industrial, which fits easily to bases where the mandrel engages drill holder; thus covering completely the drill, thus avoiding the risk of contact with said drill bit, to protect the hands during handling of said bore; other under this device is to set the measure, according to the need of drilling and allow this to be perfectly repeatable without varying the measure, preventing rework for errors in the depth of a bore; also it allows collecting waste generated when performing a drilling even roof, thereby protecting the goods and goods and because independent deposit area of the mandrel or tool, extends the life of the holes by isolating the waste; due to the possibility of manufacturing transparently allows complete visualization of the bit when taking drilling, with a more ergonomic grip to increase the possibility of a force more evenly and distributed and increase the contact area of the surface drilling and if necessary in special applications drilled as (glass, acrylic, metal, steel . . . ) deposit of waste acts as a container that dispenses lubricating the drill.

### Advantages of the Invention

The rigid retractable telescopic device (100) is a telescopic & optimizer protector using art for drills; which provides the following advantages:
Protection and total attendance for the user and the surface to be drilled; because through this rigid retractable telescopic device, the user is protected hands, giving total industrial or domestic security for use; and in turn protects the site where it will drill and its surroundings.
also it protects the drill and surrounding work equipment; as their deposit and seal systems, plushes, and provide a seal rubbers and ability to store waste, preventing its passage to drill and turn to surrounding equipment.
Avoid gloves, goggles, masks and covering furniture; this because the area of the drill bit and the chuck, completely isolating, this risk is coated.
Collect 98% of the rubble; this means the tank and seal systems, plushes, and rubber that provide great tightness and ability to store waste, preventing affecting the surrounding equipment.
Set the exact depth with repeatability; by means of a retractable telescopic mechanism graduated with precise measurements, which can be set by way of screw-nut and locknut; and thus it remained unchanged, facilitating, repeat the same drilling depth as often as necessary, this also ensures that in the case of rejections, will always stay with the perfect depth, as when drilling not it is complete the rejection is visible, and uncomfortable the other assemblies, and in case we exceed its depth, this will go to the bottom of the wall, losing his grip; this without counting cases where due to an error in drilling, we are led to perform rework, which in some cases turn out to be complex, as when we drill hydraulic pipes or electrical installations.
ago flawless perforation 90°, even on smooth surfaces; this is achieved since the area that is in contact with the wall, forming a kind of membrane or almost airtight seal, which significantly reduces slippage, and in turn provides perpendicularity of the drill with the surface to be drilled, ie extremely important in surfaces smooth walls and even in applications, such as glass, acrylic, metal sheets, foils and others.
it is self-retracting □ for ease of use; this is achieved through the joint and the box spring or area where it is housed, in association with the telescopic system; wherein the spring energy absorbed when drilling, released when it comes out, facilitating recoil and turn always ensuring that the bit and mandrel will be covered.
have special insurance for children; this in the case that even the hole is plugged, allow the child to engage it not be hurt by the bit.
It can include a belt for “hands-free”; this system is vital in cases of work at heights, where all tools should be hung and secured, thus ensuring safe work for the operator.

### SUMMARY OF THE INVENTION

The rigid retractable telescopic device (100) with ergonomic grips, which protects the wearer, fixed as drilling, collects waste, increases the contact area, enables full visualization and if necessary metered lubrication comprising: a device it is installed on the top of the mandrel or rotating tool which fits a handle; and a cover with protective elements, is installed on the top of the mandrel or rotary tool, of which the adjustment handle and grip is set (1), through the mini-handle socket (16), nut mini-mango (17), endless strip (18) screw nut screw adjustment to the strip (19), in accordance with the joining tool solidarity to it; and long handle with ergonomic tank (20) and cap ergonomic handle (21) enabling gripping there of by the user; and then in direct contact, forming a right angle of 90° is adjacent the cylinder regulated male threaded grip (2), with locknut depth adjustment (7), threading the setting cylinder female screw (3), to which the retractable cup (4) is coupled with the collector container cover (5), continuing the protective cap (6) which is secured to the protective cover fixing ring (10); in the collector container cover (5), the flexible base slip contact (8) is also housed, with the final packaging collection cup (9); where the other end and in the middle of the collection container (5) and the retractable glass (4), the ring is mini cover (10); in the setting cylinder female thread (3), internally it fits the first felt (11a), which is the front end of the retractable cup (4) and the second felt (11b), which fits internally and is located in thereinto retractable cup (4), towards the same end, wherein the first seal (13) is located, the second packaging glass side (14) is located beside the cylinder regulated male threaded grip (2), wherein the spring (12) is housed within the retractable also glass (4); the end of the cylinder regulated male threaded grip (2), and to the adjustment handle and grip (1) the strip (15) is located, which encloses the circumference of said regulated male threaded gripping cylinder (2); wherein internally of the circumference of said cylinder regulated male threaded grip (2), and depending on the type of drill wireless adapter (22), or wireless pro adapter (23) or the standard adapter (24) is installed; which can go with guides fit and lace; where also is the belt (25), which ensures the male tube (2); which can have multiple adjustment and manilar of charge, or a direct coupling of the male tube (2); or unified coupling adapter (26) meets measures adapters: wireless (22), or pro wireless (23), or standard (24).

Wherein the container collector cover (5) is a cylinder may have conical variations with ways to increase its capacity or storage volume, which can have a system of rapid graduation, as the vessel of universal retractable auto device; through internal guides which engage and wedge the extent required, on the outside of the retractable cup (4), or an Internal thread, in the container lid collector (5) and external thread on the lifting vessel (4); the container collector cover (5) is formed externally ergonomically which improves grip the rigid retractable telescopic device (100), which at its front face is the flexible base slip contact (8) which presents, zone or wide increases the surface area in contact with the wall, floor, ceiling or any area to be worked on, being positioned perpendicular to the 90° tool that area; when the rigid retractable telescopic device (100), is not being used the protective cap (6) that is secured to the ring mini cover (10) which is housed in the slotted having the container collector cover (5) to make sure its frontal end; on the front toward the center of the container collector cover (5), the final packaging collection cup (9), which may vary on your way to seal, as the material can be rubber is installed, which can take several packages in one, so that with small equally spaced openings, and crisscrossed provide this first seal; is a package with internal particularity in its center that has two independent movements to join or vulcanized form a single piece, and therefore helps prevent the passage of waste to the other chamber or cover collection container (5) can be manufactured in any rigid material (plastics, polymers, metals, aluminum, wood, acrylic, glass . . . etc.) or semi-rigid materials (rubber-plastic alloys, rubber-metal . . . etc.); and in any color being one of the transparent disclosed by this invention; also this vessel collector (5) to generate a tightness way of sucking cap may also contain dosed lubricating fluids (water, oils or fats) in industrial applications or special smooth materials (holes in sheets or sheet metal, aluminum, acrylics, acrylics, glass . . . etc.) that lubricates the rotation tool.

Wherein the retractable cup (4) is a cylinder takes the same ergonomic shape, which brings the container collector cover (5), which fits by way of male and female, being the retractable cup (4) the male; which can have a system, rapid graduation degree, through externally configured equidistant graduated in centimeters and even millimeters, where they fit, interlock and ensure the guides of the container collector cover (5) providing an extra supply channels for adjusting the extent required quickly, according to the rejection or the required depth of the drill bit; system or external thread in the retractable cup (4), and internal collector in container lid (5) to the front side; wherein the opposite end of the container collector cover (5) are at least two guides that fit and allow the sliding of the retractor system, caused by the compression spring (11), inside this retractable cup (4) as by retractable glass front face (4), the seat lace spring (11) is located, which sits on the opposite side, with the female threaded cylinder regulator (3); that guides plus slide and allow retractilidad can also be locked or secured, as a childproof, thus avoiding a possible puncturing, and the bit would be fully covered, and the rigid retractable telescopic device (100) secured being inoperative the retractilidad thereof; retractable cup (4), it can be manufactured in any rigid material (plastics, polymers, metals, aluminum, wood, acrylic, glass . . . etc.) or material semi-rigid (alloys rubber-plastic, rubber-metal . . . etc.); and any colored or transparent.

Where the regulator cylinder threaded female (3), is a perfect cylinder with grooved and locking the outer guides, and internal thread millimeter graduation to graduate, to the extent required accurately by means of the cylinder regulated male threaded grip (2), which ensures the measurement with the depth adjustment locknut (7), according to rejection or the required depth of the drill bit; the setting cylinder female thread (3) on its front face housing the spring (11) in a smooth cylindrical chamber when fully compressed, where the center the first felt (11a) are located, and the second felt (11b), and the opposite side of this camera is the continuous internal thread; the setting cylinder female thread (3) may be made of any rigid material (plastics, polymers, metals, aluminum, wood, acrylic, glass . . . etc.) or semi-rigid (alloys rubber-plastic, rubber-metal . . . materials etc.); and any colored or transparent.

Where in the cylinder regulated male threaded grip (2) is a cylinder with external thread on the entire front and on the back a configuration of an enlarged, conical cylinder with recesses or flexible flanges that facilitate securing by means of a strip (15), holding the entire hard retractable telescopic device (100), the mandrel or rotary tool, of which the adjustment handle and grip (1) fits, which through the hub mini-handle (16), mini-handle nut (17), endless screw strip (18), adjusting nut screw the strip (19), which fit with the joining tool solidarity to it; with long handle with ergonomic tank (20) and cap ergonomic handle (21) enabling gripping thereof by the user; the cylinder regulated male threaded grip (2), on the face of the mandrel it presents different forms of adjustment, ranging according to the type of drill: wireless adapter (22), or the wireless pro adapter (23) or the standard adapter (24); which can go with guides fit and lace, where the belt (25) is also secured, the male tube (2); which can have multiple adjustment and manilar of charge, or a direct coupling to the chuck of the male tube (2), the cylinder regulated male threaded grip (2) can be manufactured in any rigid material (plastics, polymers, metals, aluminum, wood, acrylic, glass etc. . . . ) or semi-rigid materials (rubber-plastic alloys, rubber-metal . . . etc).; and any colored or transparent.

Where in the adjustment handle and grip (1), where they are housed inside the elements ensuring the rigid retractable telescopic device (100) to the drill chuck, through the mini-handle (16) hub, the strip (15), the mini-handle (17) nut, the endless strip (18) screw nut screw adjustment to the strip (19), which fit with the tool or drill, joining in solidarity; and long handle with ergonomic tank (20), and ergonomic handle cover (21), enabling gripping thereof by the user; the adjustment handle and grip (1), it is the final part of the rigid retractable telescopic device (100), and forms a perpendicular with the drill, which provides a safe way a great fit and support to force thrust into the drilled; Besides this you can Install a belt for working on heights, there by ensuring the tool or drill, and the rigid retractable telescopic device (100), the bottom of the adjustment handle and grip (1) ends with the nut screw adjustment to the strip (19) which has undulations easy grip to perform the required adjustment, this adjustment handle and grip (1), can be manufactured in any rigid material (plastics, polymers, metals, aluminum, wood, acrylic, glass etc. . . . ) or semi-rigid materials (rubber-plastic alloys, rubber-metal . . . etc).; and any colored or transparent.

Where in the ergonomic long handle with tank (20) is the part that is in direct contact with the adjusting nut screw to the strip (19), by means of a threaded end by way of screw, and a smooth washer to facilitate the rotation of the adjustment nut screw the strip (19), and in the end will cover handle (21), ergonomic long handle with tank (20) is a hollow part Inside, lined with an ergonomic material easy grip, long handle with ergonomic tank (20) and cap ergonomic handle (21) can be manufactured in any rigid materials (plastics, polymers, metals, aluminum, wood, acrylic, glass . . . etc.) or semi materials rigid (alloys of rubber-plastic, rubber-metal . . . etc.); and any colored or transparent.

Where in the coupling or unified adapter (26) meets the adapter measurements: wireless (22) or the pro wireless (23) or the standard (24), through the engagement of the protrusions with the male tube (2), where depending the shape of lace diameter altered to fit, according to the need for coupling with different drills: wireless, pro wireless or wired standard; This coupling or unified adapter (26) has protuberances around its diameter, about equal distances, which together with the fins of existing spaces or recess in the male tube (2) ensure that for each type of fitting diameter; wherein the coupling or unified adapter (26) has a protuberance or ridge on the opposite side of the opening which has two inclined fins also ensure said lace for other diameter measurement the drill chuck, they can be made in materials semi-rigid (alloys of rubber-plastic, rubber-metal . . . etc.); and any colored or transparent.

Wherein the belt (25) secures the male tube (2); strong and resiliently behind the drill, which can have multiple fit with cross-manilar of charge, which completely rigid retractable telescopic device (100) with the drill.

Where in an alternative of the invention, the rigid retractable telescopic device (100), no ergonomic long handle with a deposit (20) and cap ergonomic handle (21) allowing the user's grip is made in the bore and the other hand on the same rigid retractable telescopic device (100); which is installed on the top of the mandrel or rotary tool, of which the adjustment handle and grip is set (1), through the mini-handle socket (16), nut mini-handle (17), screw end of the strip (18), adjusting nut screw the strip (19), in accordance with the joining tool solidarity to it; and the short handle (20) attached so adjusting screw; and then in direct contact, forming a right angle of 90° is adjacent the cylinder regulated male threaded grip (2), with locknut depth adjustment (7), threading the setting cylinder female screw (3), to which the retractable cup (4) is coupled with the collector container cover (5), continuing the protective cap (6) which is secured to the protective cover fixing ring (10); in the collector container cover (5), the flexible base slip contact (8) is also housed, with the final packaging collection cup (9); where the other end and in the middle of the collection container (5) and the retractable glass (4), the ring is mini cover (10); in the setting cylinder female thread (3), internally it fits the first felt (11a), which is the front end of the retractable cup (4) and the second felt (11b), which fits internally and is located in thereinto retractable cup (4), towards the same end, wherein the first seal (13) is located, the second packaging glass side (14) is located beside the cylinder regulated male threaded grip (2), wherein the spring (12) is housed within the retractable also glass (4); the end of the cylinder regulated male threaded grip (2), and to the adjustment handle and grip (1) the strip (15) is located, which encloses the circumference of said regulated male threaded gripping cylinder (2); wherein internally of the circumference of said cylinder regulated male threaded grip (2), and depending on the type of drill wireless adapter (22), or wireless pro adapter (23) or the standard adapter (24) is installed; which can go with guides fit and lace; where also is the belt (25), which ensures the male tube (2); which can have multiple adjustment and manilar of charge, or a direct coupling of the male tube (2); or unified coupling adapter (26) meets measures adapters: wireless (22), or pro wireless (23), or standard (24).

Process assembly rigid retractable telescopic device (100) with ergonomic grips, which protects the wearer, fixed as drilling, collects waste, increases the contact area, enables full visualization and if necessary metered lubrication comprising: a device that is installed on the top of the mandrel or rotating a handle which tool is adjusted; and a cover with protective elements comprising the following steps:
begins with the pre assemblies of components that will adjust on the top of the mandrel or rotary tool, these are the adjustment handle and grip (1), through the mini-handle hub (16), nut mini-handle (17), endless screw strip (18), adjusting nut screw the strip (19), in accordance with the joining tool solidarity to it; through and ergonomic long handle with tank (20) by way of screw and nut which are screwed and adjusted to achieve the extent required by the strip (15), which surrounds the circumference of that regulated threaded barrel male grip (2), and then the cover ergonomic handle (21) enabling gripping thereof by the user,
Then the following items are assembled: the locknut depth adjustment (7), threading with the regulated male threaded clamping cylinder (2), and this in turn thread with the threaded regulator cylinder female (3), where the first seal (13) is located, and the second packaging glass side (14) and depending on the type of drill is installed or fits in the regulated threaded male grip (2) the following adapters cylinder: wireless adapter (22), or the pro wireless adapter (23) or the standard adapter (24), which can go with guides fit and lace; or coupling or unified adapter (26); or a direct coupling of the male tube (2).
Then coupled via adjustment channels and graduation measures, or failing threadedly regulator cylinder threaded female (3), the retractable glass (4), together with the container collector cover (5), where also retractable into the vessel (4), the spring (12) is installed; the end of the cylinder regulated male threaded grip (2), wherein the other end and in the middle of the collecting container (5), and the retractable cup (4), the ring is mini cover (10); within the regulatory cylinder threaded female (3), also fits and internally hits the first plush (11a), which is the front end of retractable cup (4), and snaps and hits the second felt (11b), which fits and is located internally, inside the same retractable cup (4).
Then the protective cap (6) which is secured to the protective cover fixing ring (10) is coupled; in the collector container cover (5), also staying and paste the flexible base slip contact (8), with the final packaging collection cup (9); where the other end and in the middle of the collection container (5) and the retractable glass (4), the ring Is mini cover (10).
Finally the rigid retractable telescopic device (100) is located in the mandrel installing the adapter (22), (23), (24) or (26), corresponding and if necessary the belt (25), giving fit with long handle ergonomic with deposit (20), then ensure as drilling, it may be with the length of rejection, and adjusting it with the locknut depth adjustment (7), threading with the regulator cylinder threaded female (3).

Where in the container collector cover (5), fits in the form of a cylinder, and can also fit with tapered variations in ways that enhance their ability or storage volume, you may also have a lace through a system of rapid graduation, measuring the auto glass universal retractable device; through internal guides which engage and wedge the extent required, which engages the outside of the retractable cup (4) with an internal thread in the container collector cover (5) and external thread on the retractable cup (4); in the collector container cover (5) by its front face is coupled the flexible base slip contact (8) to facilitate positioning perpendicularly to 90°; It engages the rigid retractable telescopic device (100) the protective cap (6), when not being used which is secured to the ring mini cover (10) which is housed in the slotted having the container collector cover (5) to its frontal end; the final packaging collection cup (9) in the front toward the center of the container collector cover (5), which may vary on your way to seal, as the material can be rubber, which can be installed take several packages in one, so that with small equally spaced openings, and crisscrossed provide this first seal; is an internal packaging with particularity in its center that has two independent movements to join or vulcanized form a single piece, and therefore helps prevent the passage of waste to the other chamber or collection container lid (5).

Where in the retractable cup (4) has a cylinder shape takes the same ergonomic shape, which brings the container collector cover (5), which engages or engage way of male and female, being the retractable cup (4) the male; which can have a system, rapid measurement graduation, through externally configured equidistant graduates in centimeters and even millimeters, where they fit, interlock and ensure guides collector container cover (5) channels; or is screwed or an external thread system in the retractable cup (4), and internal collector in container lid (5) to the front side; wherein the opposite end of the container collector cover (5) are at least two guides that fit or engage and allow sliding of the retractor, where is installed inside the spring, causing the compression spring (11), the inside this retractable cup (4)); that guides plus slide allow retractilidad can also be locked or secured, as a childproof, thus avoiding a possible puncturing, and the bit would be fully covered, and the rigid retractable telescopic device (100) secured being inoperative retractilidad it.

Where in the setting cylinder female thread (3), is set a perfect cylinder with grooved guides and locking the outside and internal thread millimeter graduation to graduate, as required accurately by the cylinder regulated male threaded gripping (2), where in turn the locknut depth adjustment (7) is secured in the threaded setting cylinder female (3) by its front spring (11) is installed in a smooth cylindrical chamber which is when fully compressed, wherein the first plush center (11a) is installed, and the second felt (11b) is installed, and the opposite side of this chamber continuous internal thread is.

Where in the cylinder regulated male threaded grip (2) is a cylinder that is threaded through the external thread presented in its front, and engages the rear face a configuration of an enlarged, tapered cylinder and recesses or flexible flanges, which facilitate the securing by means of a strip (15), which wrapping is installed round to hold all rigid retractable telescopic device (100), with the mandrel or rotary tool, and where continuous joining: the adjustment handle and grip (1), through the mini-handle socket (16), nut mini-handle (17), endless strap bolt (18), adjusting nut screw to the strap (19), which make it fit with the joining tool solidarity to it; and then the ergonomic long handle engages reservoir (20) and cap ergonomic handle (21) engages allowing gripping thereof by the user; the cylinder regulated male threaded grip (2), on the face of the mandrel it presents the installation of different forms of adjustment, ranging according to the type of drill: wireless adapter (22), or the wireless pro adapter (23), or the standard adapter (24); which can go with guides fit and lace, where the belt (25) is also secured, the male tube (2); which can have multiple adjustment and manilar of charge, or a direct coupling to the male mandrel tube (2), the cylinder regulated male threaded grip (2).

Where in the adjustment handle and grip (1), is the pizza pie where they are assembled, mating and housed inside the elements ensuring the rigid retractable telescopic device (100) to the drill chuck, through: the mini hub-mango (16), the strip (15), the mini-handle (17) nut, the endless band (18) screw, the adjustment nut screw to the strip (19), adjusting the tool or drill, joining in solidarity to it; and then the ergonomic long handle tank (20) is couplet, and then cover ergonomic handle (21) in the bottom of the adjustment handle and grip (1) engages the adjusting nut screw is installed to the strap (19) which has undulations easy grip to perform the required adjustment.

Where in the ergonomic long handle with tank (20) is installed being in direct contact with the adjusting nut screw to the strip (19), as a bolt and nut via a threaded end by way of screw and washer smooth which facilitates the rotation of the adjustment nut screw to the strip (19), and end thirst installs the handle cap (21), the ergonomic long handle with a deposit (20) may be a hollow part inside, lined with an ergonomic easy grip material.

Where in the coupling or adapter unified (26) is coupled depending on the type of tool used meets the adapter measurements: wireless (22) or the pro wireless (23) or the standard (24), through the lace the protuberances with the male tube (2), wherein depending on the shape fitting the diameter altered to fit, according to the need for coupling with different drills: wireless, pro wireless or wired standard; This coupling or unified adapter (26) fits through protuberances around its diameter, about equal distances, which together with the fins recess or existing spaces in the male tube (2) ensure that fit for each type diameter; wherein the coupling or unified adapter (26) is coupled via a bump or ridge on the opposite side of the opening which has two inclined fins also ensure said lace for another measure of the mandrel bore diameter.

Where in the belt (25) is installed ensures the male tube (2); strong and resilient manner taking it and extending behind the drill, which can have multiple adjustment crossed with a kind of manilar of charge, which completely connects the rigid retractable telescopic device (100) with the drill.

Where in an alternative of the invention, the rigid retractable telescopic device (100), is coupled a handle (20) that no deposit or cover ergonomic handle (21) allowing the user's grip is made in the drill and the other hand on the same rigid retractable telescopic device (100); which is installed on the top of the mandrel or rotary tool, of which the adjustment handle and grip is set (1), through the mini-handle socket (16), nut mini-handle (17), screw end of the strip (18), adjusting nut screw the strip (19), in accordance with the joining tool solidarity to it; and the short handle (20) attached so adjusting screw; and then in direct contact, forming a right angle of 90° is adjacent the cylinder regulated male threaded grip (2), with locknut depth adjustment (7), threading the setting cylinder female screw (3), to which the retractable cup (4) is coupled with the collector container cover (5), continuing the protective cap (6) which is secured to the protective cover fixing ring (10); in the collector container cover (5), the flexible base slip contact (8) is also housed, with the final packaging collection cup (9); where the other end and in the middle of the collection container (5) and the retractable glass (4), the ring is mini cover (10); in the setting cylinder female thread (3), internally it fits the first felt (11a), which is the front end of the retractable cup (4) and the second felt (11b), which fits internally and is located in thereinto retractable cup (4), towards the same end, wherein the first seal (13) is located, the second packaging glass side (14) is located beside the cylinder regulated male threaded grip (2), wherein the spring (12) is housed within the retractable also glass (4); the end of the cylinder regulated male threaded grip (2), and to the adjustment handle and grip (1) the strip (15) is located, which encloses the circumference of said regulated male threaded gripping cylinder (2); where in internally of the circumference of said cylinder regulated male threaded grip (2), and depending on the type of drill wireless adapter (22), or wireless pro adapter (23) or the standard adapter (24) is installed; which can go with guides fit and lace; where also is the belt (25), which ensures the male tube (2); which can have multiple adjustment and manilar of charge, or a direct coupling of the male tube (2); or unified coupling adapter (26) meets measures adapters: wireless (22), or pro wireless (23), or standard (24).

### DESCRIPTION OF THE DRAWINGS

FIG. 1. Prior art figure from document WO2014/067497.

FIG. 2. Isometric universal self telescopic device shrinkable rigid material (100) with ergonomic grips, which protects the wearer, fixed as drilling, collects waste, increases the contact area, enables full visualization and if necessary metered lubrication; as an alternative of the invention this has an elastic conical mandrels for wireless setting a manifold and rapid graduation.

FIG. 3. Isometric universal self telescopic device shrinkable rigid material (100) with ergonomic grips, which protects the wearer, fixed as drilling, collects waste, increases the contact area, enables full visualization and if necessary metered lubrication.

FIG. 4. Isometric universal self telescopic device shrinkable rigid material (100) with ergonomic grips, which protects the wearer, fixed as drilling, collects waste, increases the contact area, enables full visualization and if necessary metered lubrication; as an alternative of the invention this has a rounded form of larger volume in the collecting pipe and the glass with ergonomic difference.

FIG. 5. Isometric exploded Universal Auto telescopic device shrinkable rigid material (100) with ergonomic grips, which protects the wearer, fixed as drilling, collects waste, increases the contact area, enables full visualization and if necessary dosed lubrication; as an alternative of the invention this has an elastic conical mandrels for wireless setting a manifold and rapid graduation.

FIG. 6. Isometric exploded Universal Auto telescopic device shrinkable rigid material (100) with ergonomic grips, which protects the wearer, fixed as drilling, collects waste, increases the contact area, enables full visualization and if necessary dosed lubrication.

FIG. 7. Isometric exploded Universal Auto telescopic device shrinkable rigid material (100) with ergonomic grips, which protects the wearer, fixed as drilling, collects waste, increases the contact area, enables full visualization and if necessary dosed lubrication; as an alternative of the invention this has a rounded form of larger volume in the collecting pipe and the glass with ergonomic difference.

FIG. 8. Isometric exploded universal retractable car, rigid material (100) simple without packaging or felts sealing or setting, which protects the user telescopic device, fixed as drilling, collects waste, increases the contact area allows visualization Total doses and if necessary lubrication.

FIG. 9. Isometric exploded view of an alternative self universal telescopic retractable simple device, rigid material (100) without the long handle with ergonomic tank (20).

FIG. 10. Isometric view and cut and grip adjustment handle (1) Universal Auto retractable telescopic device, rigid material (100)

FIG. 11. Isometric views and cutting cylinder regulated male threaded grip (2) Universal Auto retractable telescopic device, rigid material (100) for small adjustable mandrels tape

FIG. 12. Isometric views of the Cylinder regulated male threaded grip (2) Universal Auto telescopic device shrinkable rigid material (100) for adjustable fit different sizes of mandrels through a set of adapters (22), (23), (24) of rubber for different types of drills, or a unified adapter.

FIG. 13. Isometric views of the Cylinder regulated male threaded grip (2) Universal Auto telescopic device shrinkable rigid material (100) for adjustable fit different sizes of mandrels through a set of adapters (22), (23), (24) of rubber for different types of drills, or a unified adapter (26).

FIG. 14. Isometric view and cut regulator female threaded cylinder (3) auto retractable universal, rigid material (100) telescopic device.

FIG. 15. Isometric view and cut glass (4) of universal retractable car, rigid material (100) telescopic device.

FIG. 16. Isometric and views of Glass (4) with rapid graduation as a collector tube system, universal auto retractable telescopic device, rigid material (100); and the glass Package (13).

FIG. 17. Isometric view and cut the drain cover (5) of universal retractable car, rigid material (100) telescopic device.

FIG. 18. Isometric and view of the manifold (5) with a system of rapid graduation as the universal retractable auto glass, rigid material (100) telescopic tube device.

FIG. 19. Isometric and views of the mini cover (6) of the universal retractable car, rigid material (100) telescopic device.

FIG. 20. And isometric views of the locknut (7) of the universal retractable car, rigid material (100) telescopic device.

FIG. 21. Isometric and views of slip (8) of universal retractable car, rigid material (100) telescopic device.

FIG. 22. Isometric and views of outer packaging collection cup (9) of the universal retractable car, rigid material (100) telescopic device.

FIG. 23. Isometric and views of the Ring Mini Cap (10), of the First Plush (11A) and the Second Plush (11B) of universal retractable car, rigid material (100) telescopic device.

FIG. 24. Isometric and views of the spring (12), the first packaging glass side (13) and second gasket (14) side male threaded cylinder universal regulated auto retractable, rigid material (100) telescopic device.

FIG. 25. Strapping and isometric views (15) Bushing Mini Mango (16), Nut Mini Mango (17) Strapping roller screw (18) Roller adjustment and adjustment strap (19).

FIG. 26. Isometric and views of Long handle tank (20) and Long Handled Cover (21).

FIG. 27. Isometric and views Wireless Adapter (22), the wireless adapter Pro (23) and standard adapter (24); with adjustment guides and lace.

FIG. 28. Isometric and views Wireless Adapter (22), the wireless adapter Pro (23) and standard adapter (24).

FIG. 29. Isometric and views of the belt (25) securing the male tube (2).

FIG. 30. Isometric and views of the belt (25) with multi-adjustable load manilar of securing the male tube (2).

FIG. 31. Isometric with options male tube (2) to engage in cordless drills.

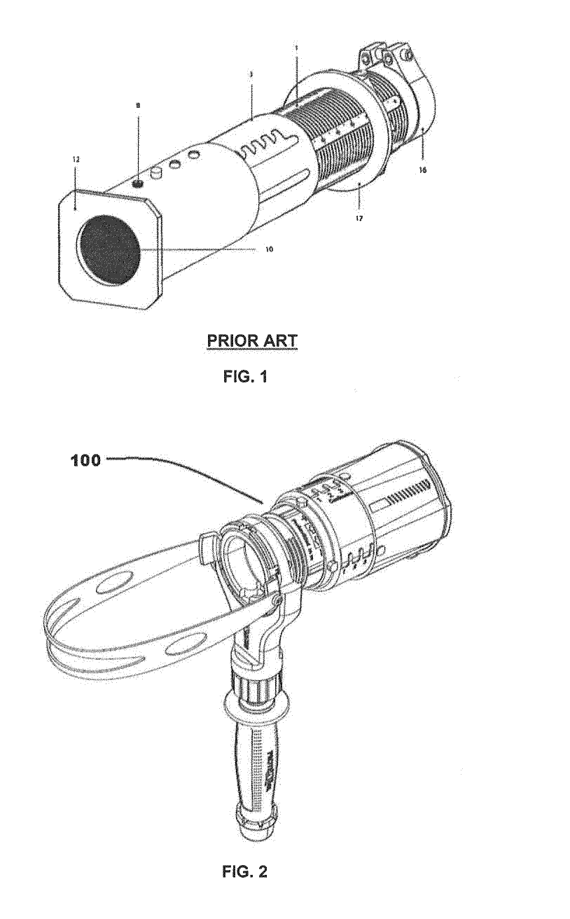

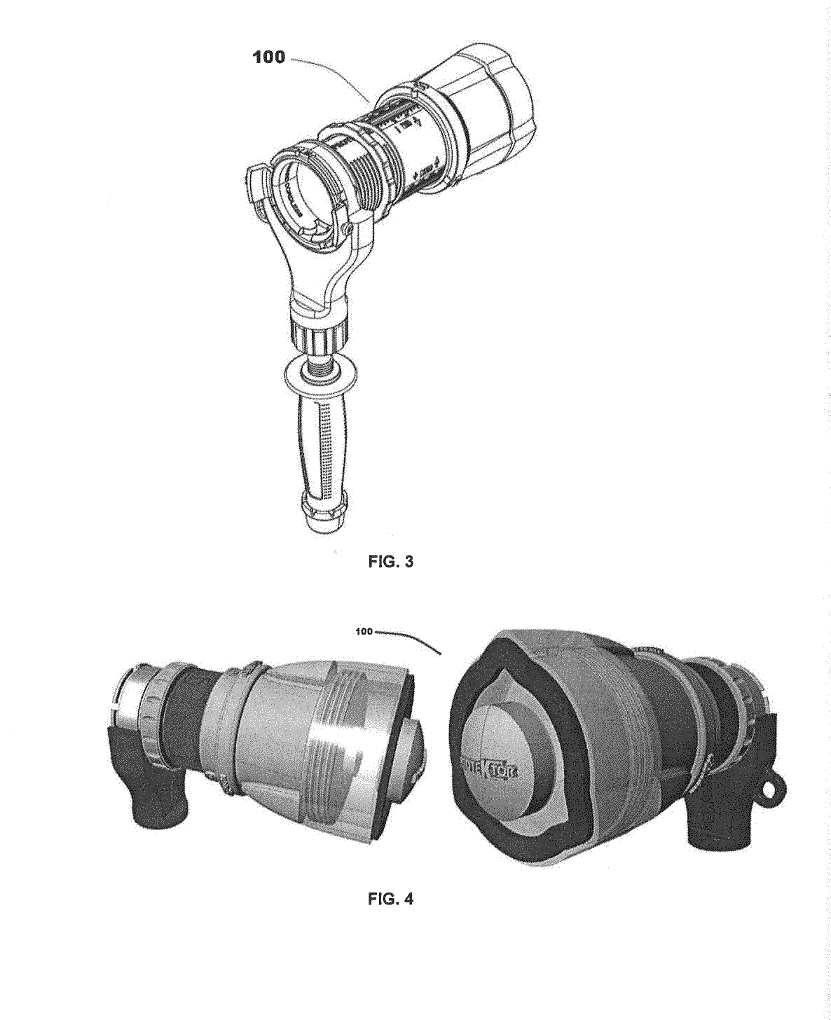

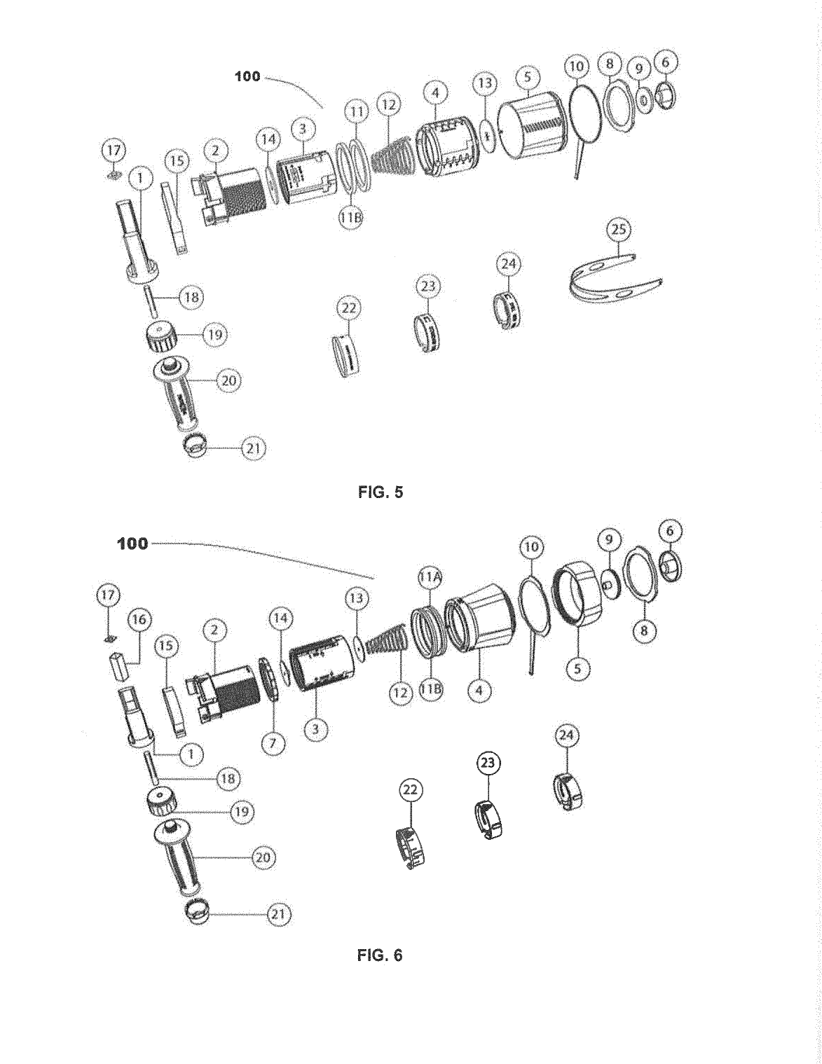

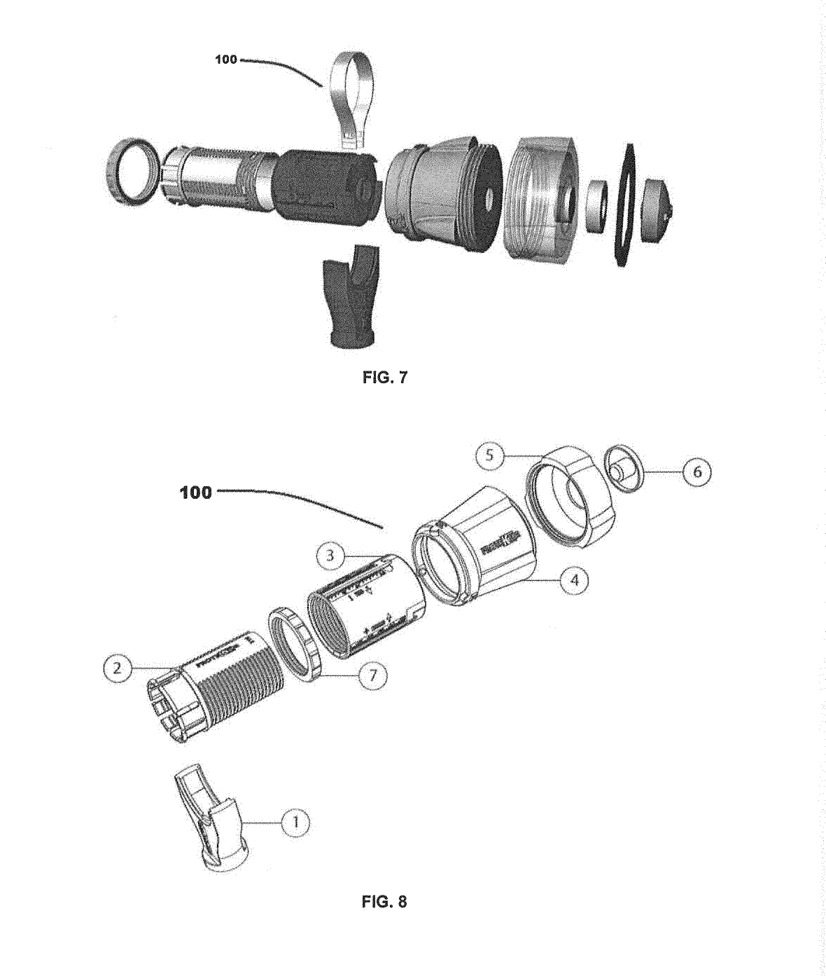

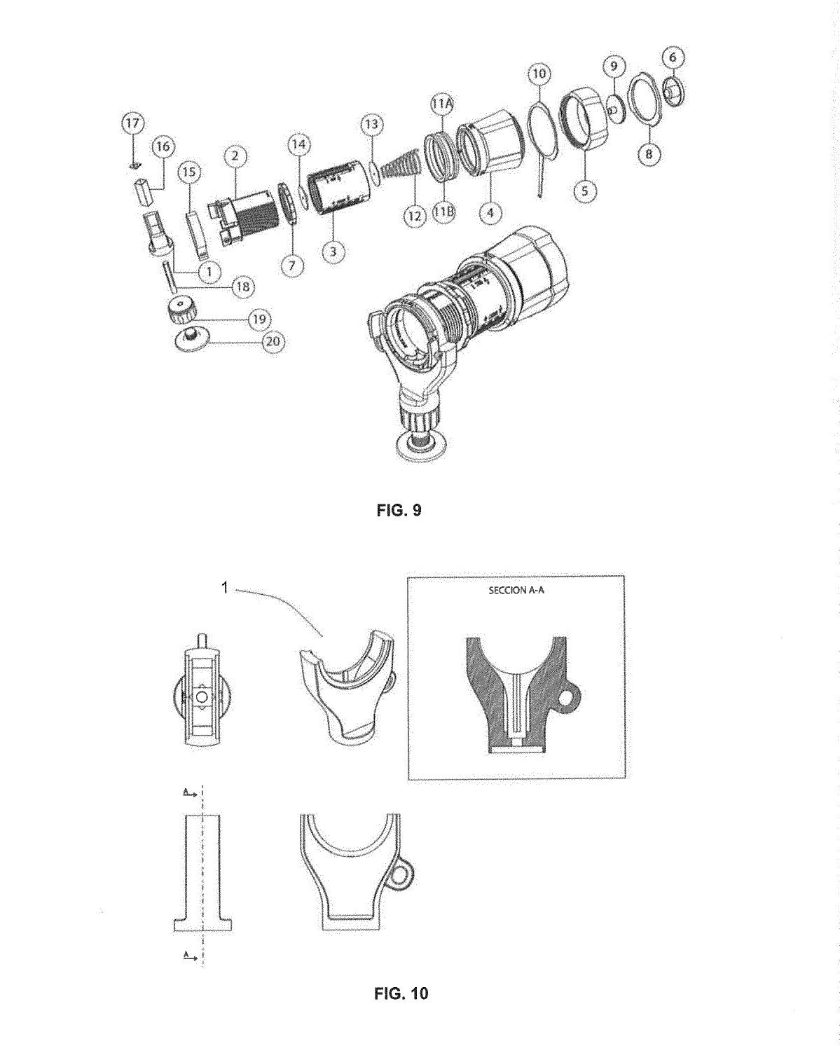

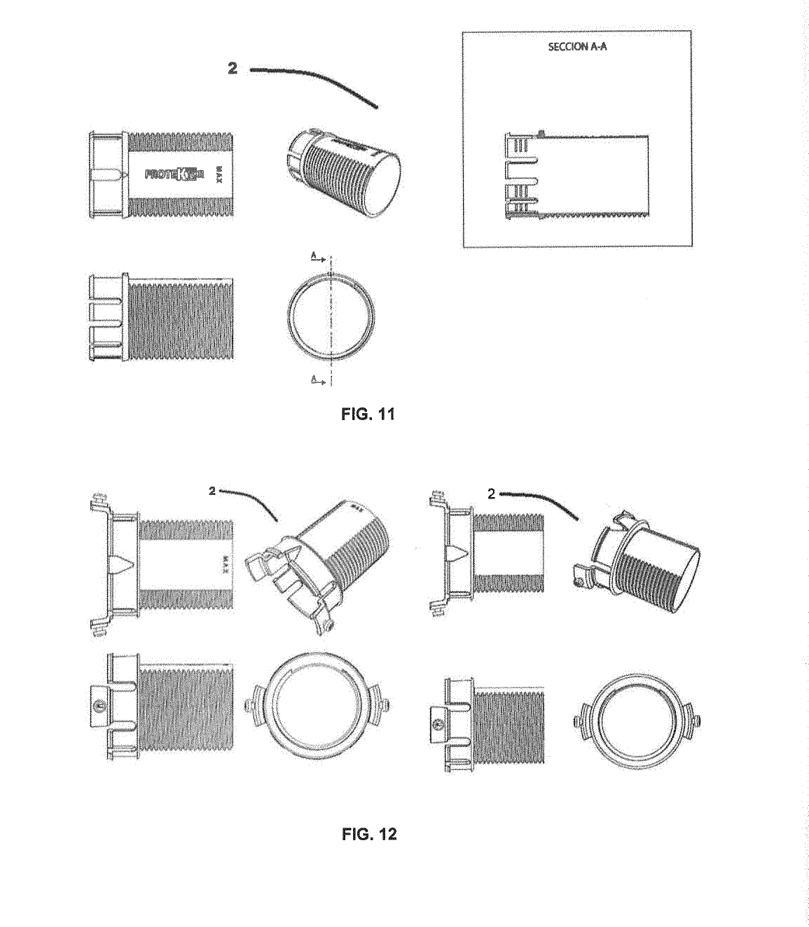

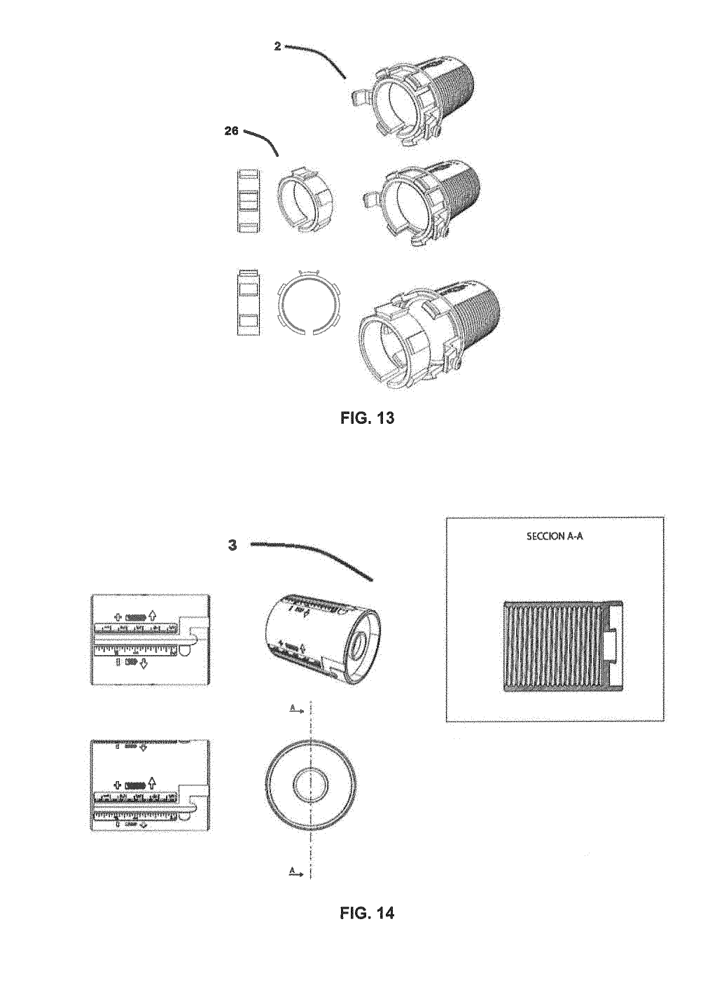

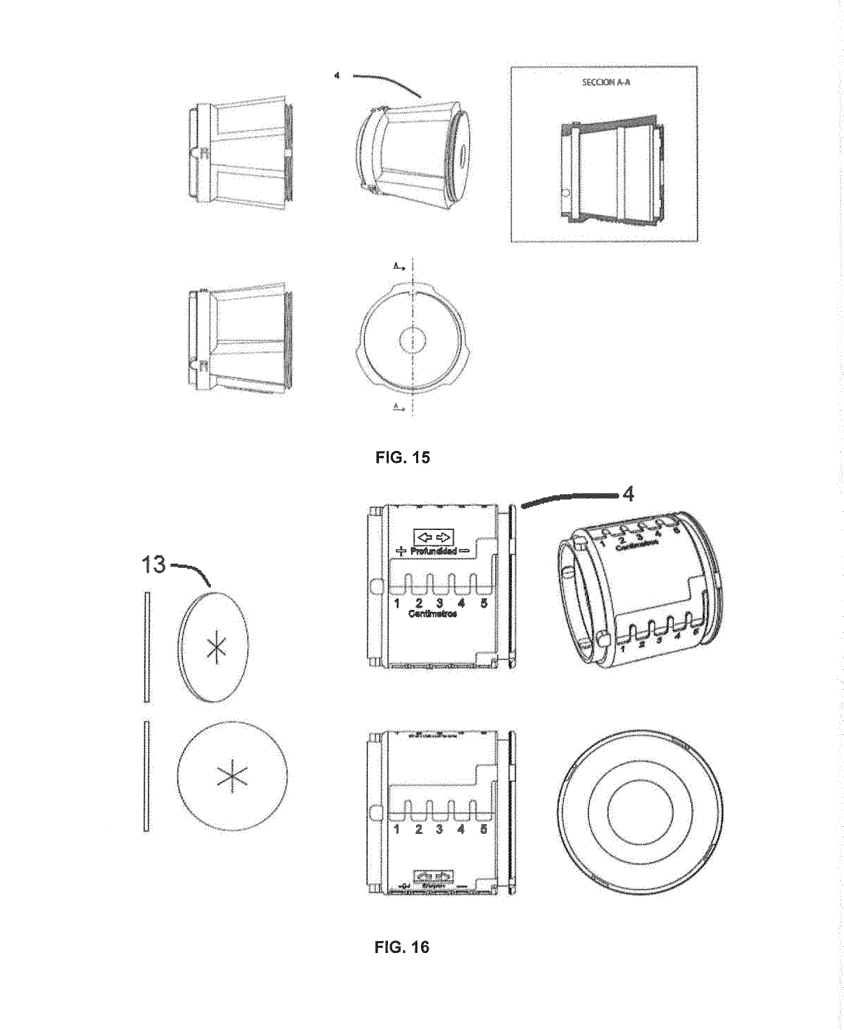

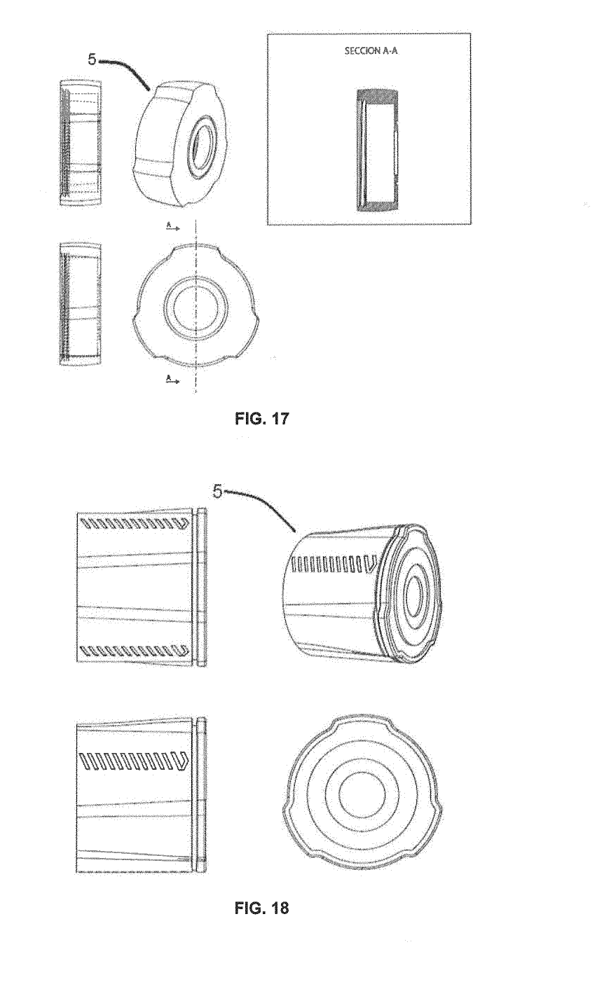

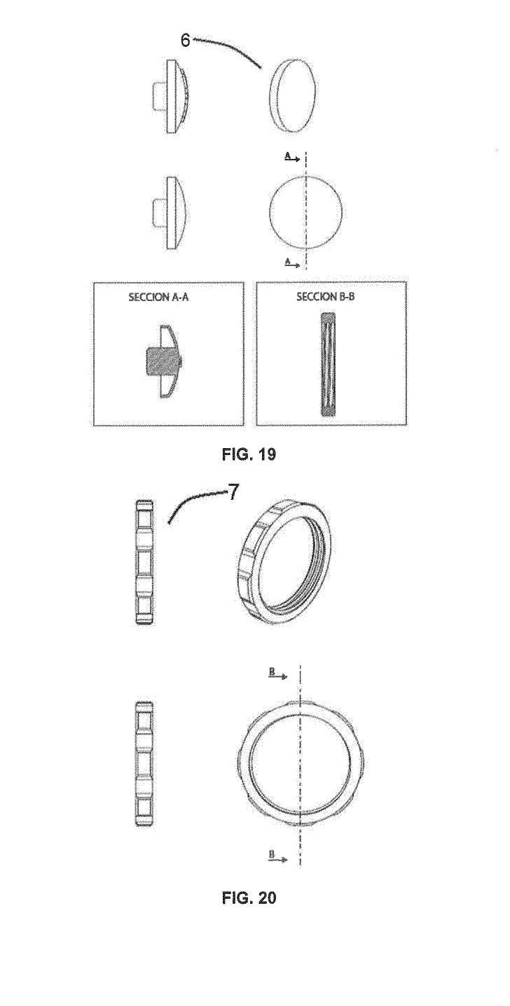

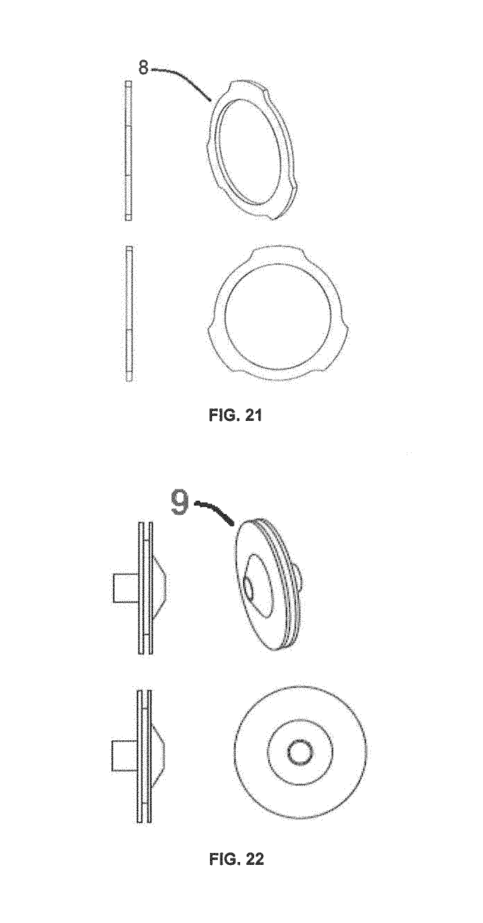

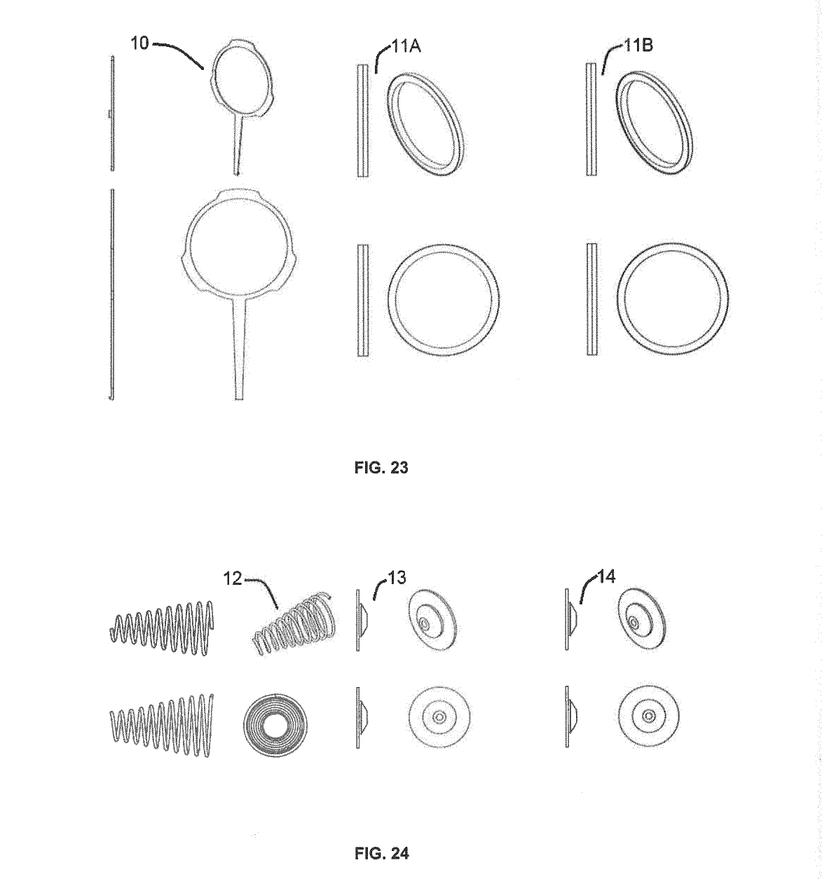

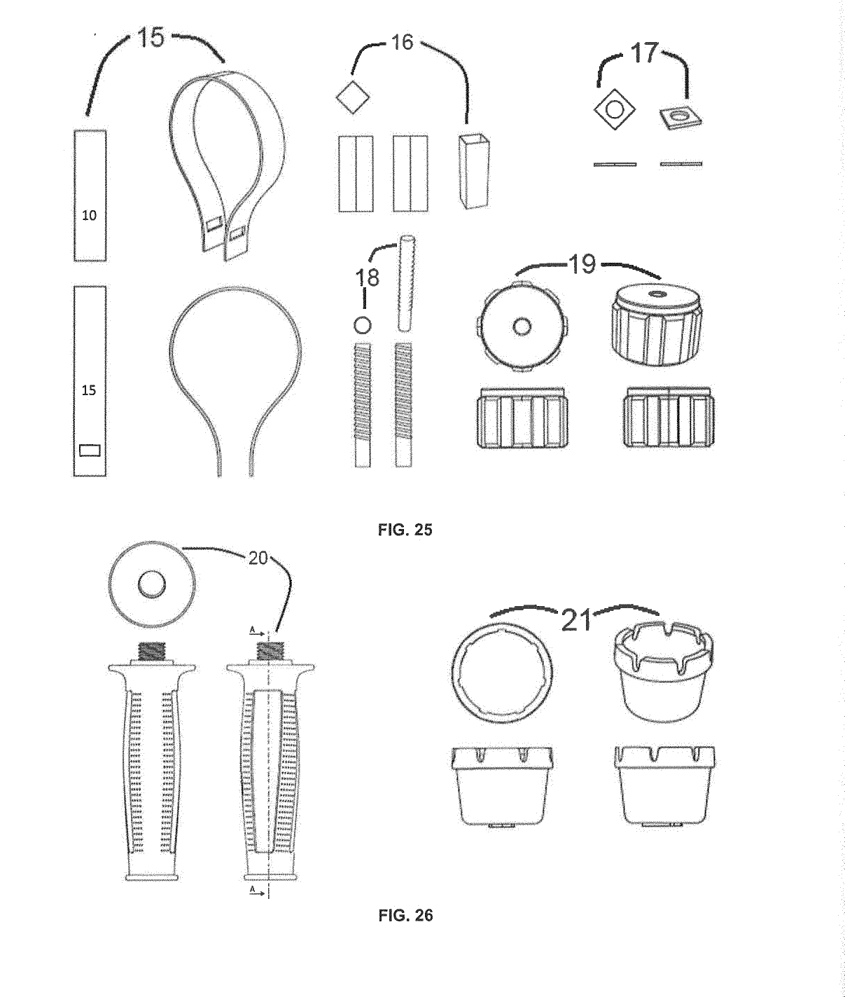

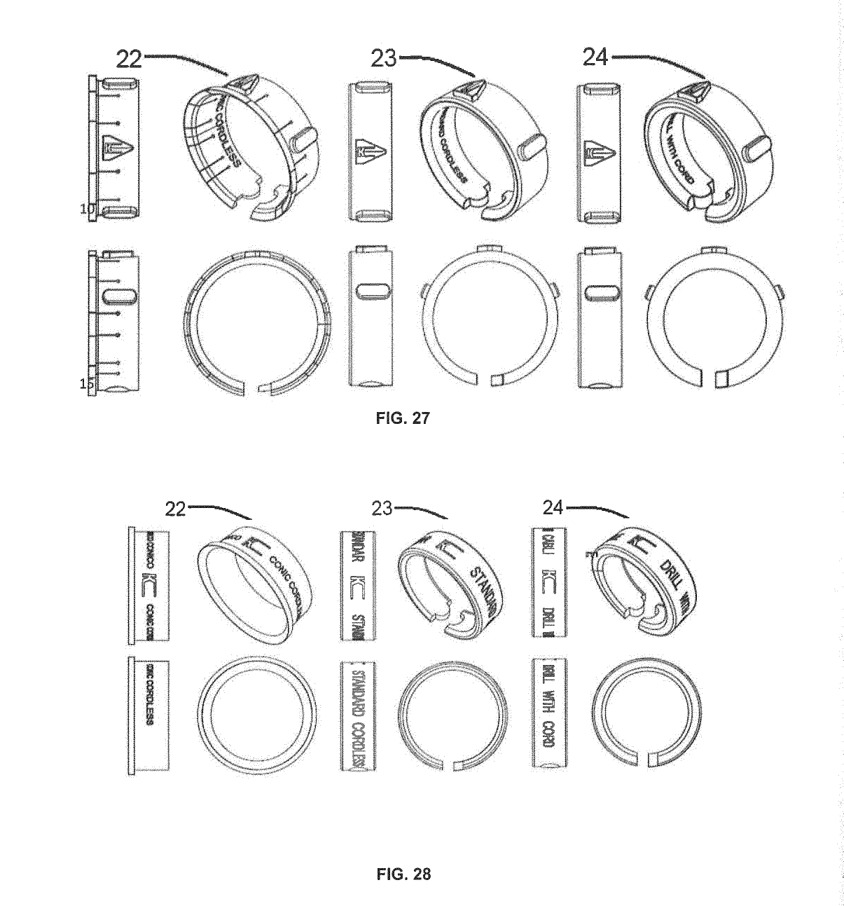

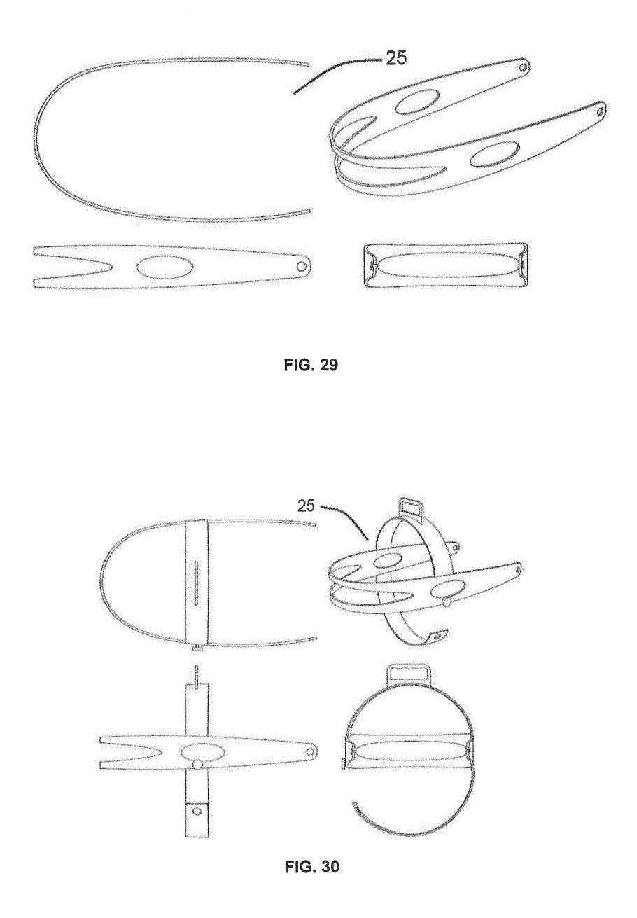

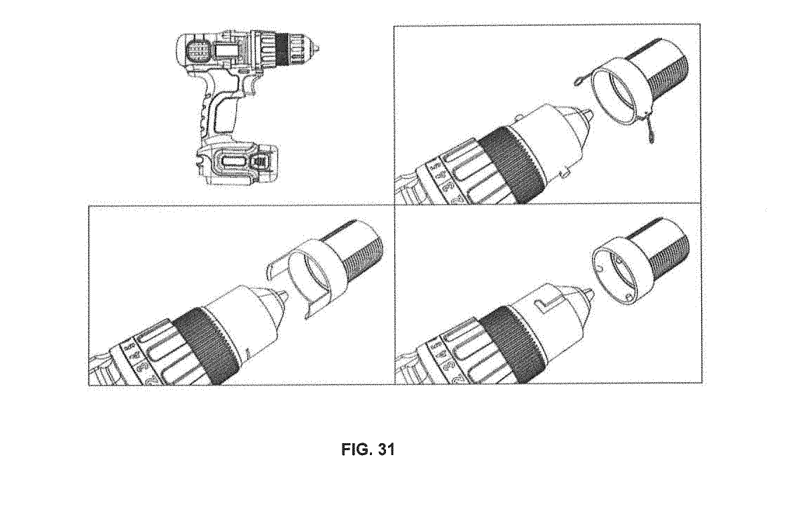

1. A rigid telescopic retractable device with ergonomic grips, which protects the user, fixed as drilling, collects waste, increases the contact area, allows full display and if necessary metered lubrication comprising: a device that is installed on the top of the mandrel or rotating a handle which fits tool; and a cover with protective elements wherein, the rigid retractable telescopic device, is installed on the top of the mandrel or rotary tool, which the adjustment handle and grip is adjusted, through the mini-handle socket, mini-handle nut, endless screw strip, adjusting nut screw the strip, in accordance with the joining tool solidarity to it; and long handle with ergonomic tank and cap ergonomic handle enabling gripping thereof by the user; and then in direct contact, they form a right angle 90° is adjacent, the cylinder regulated male threaded grip, with locknut depth adjustment, threading the threaded setting cylinder female, to which the retractable cup is coupled with the lidded collector, continuing the protective cap which is secured to the protective cover fixing ring; in the collector container cover, the flexible base slip contact is also home, with the final packaging collection cup; where the other end and in the middle of the collection container and the retractable glass, the ring is mini cover; within the female threaded cylinder regulator, internally it fits the first felt, which is the end front retractable cup and the second felt, which fits internally and is located, inside the same retractable cup, towards the same end, wherein the first seal is located the second glass packaging side is located next to the cylinder regulated male threaded grip, wherein also retractable into the vessel, the spring is housed; the end of the cylinder regulated male threaded grip, and toward the handle grip and adjusting the strip is located, which encloses the circumference, of said male threaded cylinder regulated grip; wherein internally of the circumference of said cylinder regulated male threaded grip, and depending on the type of drill wireless adapter, or wireless pro adapter or the standard adapter is installed; which can go with guides fit and lace; where also is the belt, which ensures the male tube; which can have multiple adjustment and manilar of charge, or a direct coupling of the male tube; coupling or adapter unified brings together measures adapters: wireless, or pro wireless, or standard.

2. The rigid telescopic retractable device with ergonomic grips, which protects the wearer, fixed as drilling, collects waste, Increases the contact area, enables full visualization and dosed if necessary lubrication comprising: a device that is installed on the top of the mandrel or rotating a handle which tool is adjusted; and a cover with protective elements according to claim 1, wherein the collector container lid, is a conical cylinder can present variations, with ways to increase their storage capacity or volume, which may have a system of rapid graduation, measuring the glass universal retractable self-device; through internal guides that fit together and interlock to the extent required, on the outside of the retractable cup, or an internal thread, in the container lid collector and external thread on the retractable cup; the collector container cover is formed externally ergonomically which improves grip the rigid retractable telescopic device, which at its front face is the flexible base slip contact which presents a wide area or increasing the surface area in contact with the wall, floor, ceiling or any area that will be worked, It is positioned perpendicular to the 90° tool that zone; when the rigid retractable telescopic device, is not being used the protective cap that is secured to the ring mini cover which is housed in the slotted having the container collector cover to make sure its frontal end; on the front toward the center of the collector container cover, the final packaging collection cup, which may vary on your way to seal, as the material that can be installed rubber, which can take several packages in one, so that with small equally spaced openings, and crisscrossed provide this first seal; it is an internal packaging with particularity in its center that has two independent movements to join or form a vulcanized single piece, and therefore helps prevent the passage of waste to the other chamber or collector container lid can be made of any rigid material (plastics, polymers, metals, aluminum, wood, acrylic, Glass) or semi-rigid materials (rubber-plastic alloys, rubber-metal); and in any color being one of the transparent disclosed by this invention; also this vessel collector to generate a tightness way of sucking cap may also contain dosed lubricating fluids (water, oils or fats) in industrial applications or special smooth materials (holes in sheets or sheet metal, aluminum, acrylics, acrylic, glass) that lubricates the rotation tool.

3. The rigid retractable telescopic device with ergonomic grips, which protects the wearer, fixed as drilling, collects waste, increases the contact area enables full visualization and dosed if necessary lubrication comprising: a device it installs in the top of the mandrel or rotating tool which fits a handle; and a cover with protective elements according to claim 1, wherein the retractable cup it is a cylinder takes the same ergonomic shape, which brings the collector container cover, which fits way of male and female, being the retractable cup the male; which can have a system, rapid measurement graduation, through externally configured, equidistantly graduated in centimeters and even channels in millimeters, where fit, interlock and ensure guides collector container cover providing an extra contribution required to graduate as quickly, according to rejection or to the required depth of the drill; system or external thread in the retractable cup, and internal collector in container lid to the front side; wherein the opposite end of the collector container cover are at least two guides that fit and allow slippage system retractile, caused by compression spring, retractable inside this vessel, since the front face retractable cup, the seat is spring lace, which sits on the opposite side, with the female threaded cylinder regulator; said sliding guides also allow retractilidad and can also be locked or secured, as a childproof, thus avoiding a possible puncturing, and the bit would be fully covered, and retractable telescopic rigid device being secured inoperative retractability thereof; retractable cup, it can be manufactured in any rigid material (plastics, polymers, metals, aluminum, wood, acrylic, glass) or material semi-rigid (alloys rubber-plastic, rubber-metal); and any colored or transparent.

4. A The rigid telescopic retractable device with ergonomic grips, which protects the wearer, fixed as drilling, collects waste, increases the contact area, enables full visualization and dosed if necessary lubrication comprising: a device which is installed at the top of the mandrel or rotating a handle which fits tool; and a cover with protective elements according to claim 1, wherein the female threaded cylinder regulator, It is a perfect cylinder with grooved guides and locking the outside and internal thread millimeter graduation to graduate, the extent required accurately regulated by the cylinder gripping male screw, ensuring locknut measure depth adjustment, according to rejection or to the required depth of the drill bit; the threaded cylinder regulator female on its front face housing the spring in a smooth cylindrical chamber when fully compressed, where the center the first felt a are located, and the second felt, and the opposite of this camera side the internal thread is keep going; the setting cylinder female thread may be made of any rigid material (plastics, polymers, metals, aluminum, wood, acrylic, glass) or semi-rigid (alloys rubber-plastic, rubber-metal materials); and in any color type or transparent.

5. The rigid telescopic retractable device with ergonomic grips, which protects the wearer, fixed as drilling, collects waste, increases the contact area, enables full visualization and dosed if necessary lubrication comprising: a device which is installed at the top of the mandrel or rotating tool to handle Which fits; and a cover with protective elements according to claim 1, wherein the male threaded regulated grip, the cylinder is a cylinder with external thread on the entire front and on the back of an enlarged configuration, conical cylinder with recesses or resilient lips, that facilitate securing by means of a strip, holding the entire hard retractable telescopic device, the mandrel or rotary tool, of which the adjustment handle and grip fits, which through the hub mini-handle, mini-handle nut, endless screw strip, adjusting nut screw the strip, adjusting the tool joining in solidarity to it; with long handle with ergonomic tank and cap ergonomic handle enabling gripping thereof by the user; the regulated cylinder male threaded grip, by the side of mandrel It presents different forms of adjustment, ranging according to the type of drill: wireless adapter or the wireless adapter pro or the standard adapter; which can go with guides fit and lace, where the belt is also secured, the male tube; which can have multiple adjustment and manilar of charge, or a direct coupling to the mandrel of the male tube, the cylinder regulated male threaded grip, can be manufactured in any rigid material (plastics, polymers, metals, aluminum, wood, acrylic, glass) or semi-rigid materials (alloys, rubber-plastic, rubber-metal); and any colored or transparent.

6. The rigid telescopic retractable device with ergonomic grips, which protects the wearer, fixed as drilling, collects waste, increases the contact area, enables full visualization and dosed if necessary lubrication comprising: a device which is installed at the top of the mandrel or rotating a handle which tool is adjusted; and a cover with protective elements according to claim 1, wherein the adjustment handle and grip, is the piece where the elements are housed inside that ensure the rigid retractable telescopic device to the drill chuck, through mini-handle, the strip bearing, the mini-handle nut, the endless band screw, the adjustment nut screw to the strip, adjusting with the tool or drill, joining in solidarity form to it; and long handle with ergonomic tank, and the ergonomic handle cap, allowing the grip of same user; the adjustment handle and grip, it is the final part of the rigid retractable telescopic device, and forms a perpendicular with the drill, which provides a safe way a great fit and support to force thrust into the drilled; further this can be installed on a leash for work at heights, thereby ensuring the tool or drill, and the rigid retractable telescopic device, the bottom of the adjustment handle and grip ends with the adjusting nut screw the strip which has undulations easy grip to perform the required adjustment, this adjustment handle and grip, It can be made of any rigid material (plastics, polymers, metals, aluminum, wood, acrylic, glass) or semi-rigid materials (rubber-plastic alloys, rubber-metal); and in any color type or transparent.

7. The rigid telescopic retractable device with ergonomic grips, which protects the wearer, fixed as drilling, collects waste, increases the contact area, enables full visualization and dosed if necessary lubrication comprising: a device which is installed at the top of the mandrel or rotating a handle which tool is adjusted; and a cover with protective elements according to claim 1, wherein the ergonomic long handle with tank is the part that is in direct contact with the adjusting nut screw to the strip, by means of a threaded end by way of screw, and a smooth washer to facilitate rotation of the adjusting nut screw the strip, and in the end will cover handle, the handle long ergonomic with deposit is a hollow part inside, lined with an ergonomic material easy grip, ergonomic long handle with deposit and cap ergonomic handle can be manufactured in any rigid materials (plastics, polymers, metals, aluminum, wood, acrylic, glass) or semi-rigid materials (rubber-plastic alloys, rubber-metal), and in any color type or transparent.

8. The rigid telescopic retractable device with ergonomic grips, which protects the wearer, fixed as drilling, collects waste, increases the contact area, enables full visualization and dosed if necessary lubrication comprising: a device which is installed at the top of the mandrel or rotating a handle which tool is adjusted; and a cover with protective elements according to claim 1, wherein the coupling or unified adapter meets the adapter measurements: wireless or the pro wireless or the standard, through the engagement of the protrusions with the male tube, where lace depending how the diameter is altered to fit, according to the need for coupling with different drills: wireless, pro wireless or wired standard; this coupling or unified adapter it presents protuberances around its diameter, about equal distances, which together with the fins of existing spaces or recess in the male tube ensure that for each type of fitting diameter; wherein the coupling or unified adapter has a protuberance or ridge on the opposite side of the opening which has two inclined fins also ensure said lace for other diameter measurement the drill chuck, can be made of semi-rigid materials (rubber-plastic alloys, rubber-metal); and in any color type or transparent.

9. The rigid telescopic retractable device with ergonomic grips, which protects the wearer, fixed as drilling, collects waste, increases the contact area, enables full visualization and dosed if necessary lubrication comprising: a device which is installed at the top of the mandrel or rotating a handle which tool is adjusted; and a cover with protective elements according to claim 1, wherein the belt secures the male tube; strong and resiliently behind the drill, which can have multiple fit with cross-manilar of charge, which completely rigid retractable telescopic device with the drill.

10. A rigid telescopic retractable device with ergonomic grips, which protects the wearer, fixed as drilling, collects waste, increases the contact area, enables full visualization and dosed if necessary lubrication comprising: a device which is installed at the top of the mandrel or rotating a handle which tool is adjusted; and a cover with protective elements wherein in an alternative of the invention, the rigid retractable telescopic device, no ergonomic long handle with a deposit and cap ergonomic handle allowing the user's grip is made in the bore and the other hand on the same device telescopic retractable hardtop; which is installed on the top of the mandrel or rotary tool, of which the adjustment handle and grip is set, through the mini-handle socket, nut mini-handle, screw end of the strip, adjusting nut screw the strip, in accordance with the joining tool solidarity to it; and the short handle attached so adjusting screw; and then in direct contact, it at a right angle of 90° is adjacent the cylinder regulated male threaded grip, with locknut depth adjustment, threading the threaded setting cylinder female, which engages the retractable cup, together with the collector container cover, continuing the protective cap which is secured to the protective cover fixing ring; in the collector container cover, the flexible base slip contact is also housed, with the final packaging collection cup; where the other end and in the middle of the collection container and the retractable glass, the ring is mini top; in the setting cylinder female thread, internally it fits the first felt, which is the front end of the retractable cup and the second felt, which fits internally and is located in there into retractable cup towards the same end, wherein the first seal is located, the second packaging glass side is located beside the cylinder regulated male threaded grip, wherein the spring is housed within the retractable also glass; the end of the cylinder regulated male threaded grip, and toward the handle grip and adjusting the strip is located, which encloses the circumference, of said cylinder regulated male threaded grip; wherein internally of the circumference of said cylinder regulated male threaded grip, and depending on the type of drill wireless adapter, or wireless pro adapter or the standard adapter is installed; which can go with guides fit and lace; where also is the belt, which ensures the male tube; which may have adjustment multiple, and manilar of charge, or a direct coupling of the male tube; or unified coupling adapter meets measures adapters: wireless, or pro wireless, or standard.

11. An assembly process of a rigid retractable telescopic device with ergonomic grips, which protects the wearer, fixed as drilling, collects waste, increases the contact area, enables full visualization and dispenses necessary lubrication It comprising: a device that is installed on the top of the mandrel or rotating a handle which tool is adjusted; and a cover with protective elements comprising the following steps:
a) starts with the pre assemblies of components that will adjust on the top of the mandrel or rotary tool, these are: the adjustment handle and grip, through the mini-handle hub, mini—handle nut, endless screw strip, adjusting nut screw the strip, in accordance with the joining tool solidarity to it; through and with the long handle with ergonomic tank by way of screw and nut which are screwed and adjusted to the extent necessary to achieve through the strip, which involves the circumference of said male threaded regulated gripping cylinder, and then ergonomic handle cover enabling gripping thereof by the user;
b) then the following items are assembled: the locknut depth adjustment, threading with the regulated male threaded clamping cylinder, and this in turn thread with the regulator cylinder threaded female, where the first seal is located, and the second packaging glass side and depending on the type of drill is installed or fits in the regulated threaded male grip the following adapters cylinder: wireless adapter, or pro wireless adapter or the standard adapter, which can go with guides fit and lace; or coupling or unified adapter; or a direct coupling of the male tube;
c) then coupled via adjustment channels and graduation measures, or failing threadedly regulator cylinder threaded female, the retractable glass, together with the container collector cover, where also retractable into the vessel, the spring is installed; the end of the cylinder regulated male threaded grip, wherein the other end and in the middle of the collecting container, and the retractable cup, the ring is mini cover; within the regulatory cylinder threaded female, also fits and internally hits the first plush, which is the front end of retractable cup, and snaps and hits the second felt, which fits and is located internally, inside the same retractable cup;
d) then the protective cap which is secured to the protective cover fixing ring is coupled; in the collector container cover, also staying and paste the flexible base slip contact, with the final packaging collection cup; where the other end and in the middle of the collection container and the retractable glass, the ring is mini cover; and
e) lastly the rigid retractable telescopic device is located on the mandrel by installing the adapter, corresponding and if necessary the belt, giving adjustment ergonomic long handle with deposit, then ensure as drilling, it may well be with the length of rejection, and adjusting it with the locknut depth adjustment, threading with the regulator cylinder female screw.
